(19) United States
(12) Patent Application Publication
(10) Pub. No.: US 2022/0253619 A1
(43) Pub. Date: Aug. 11, 2022

(54) Micro-track device (M-TDnm)

(71) Applicant: Mark Eklund, Ocean View, DE (US)

(72) Inventor: Mark Eklund, Ocean View, DE (US)

(21) Appl. No.: 17/300,013

(22) Filed: Feb. 8, 2021

(51) Int. Cl. G06K 7/14

(52) U.S. Cl. CPC G06K 7/14

(57) ABSTRACT

Micro-Tracking Device (M-TD^{nm}) is a micro-scale technology to assist in asset automated supply chain & logistics asset management employing OFiD (Optical Frequency Identification) and Raman scattering (a cumulative process having net effects of scattering photons and changing their frequency). This manipulation of frequency provides a ‘carrier wave’ for M-TD^{nm} interrogation via Raman spectroscopy. The component parts of the M-TD^{nm} (including silicone substrate, conduction band, and membrane) provide for an ‘E-beam resist’ function. The E-beam resist layer is coded with an arrangement of electrons, serving as a unique identifier. M-TD^{nm} is subject to interrogation via Raman spectroscopy, the Raman spectrum reading is interpreted via an optical frequency identification (OFiD) method. Likewise alternate versions and variations can include energy harvesting mechanisms via polarity and conduction choice of the arrangement of electrons, and nanowire antenna.

### CROSS-REFERENCE TO RELATED APPLICATIONS

This application claims the benefit of priority of U.S. Provisional No. 62/995,614, filed on Feb. 5, 2020, titled “Micro-Track Device (M-TD^{nm})”.

### STATEMENT REGARDING FEDERALLY SPONSORED RESEARCH & DEVELOPMENT

This invention was made independent of any government support. The United States government has no rights in the invention.

### THE NAMES OF THE PARTIES TO A JOINT RESEARCH AGREEMENT

Not Applicable. The sole inventor of this disclosure is Mark C. Eklund.

### STATEMENT REGARDING PRIOR DISCLOSURES BY THE INVENTOR

Prior disclosure(s) include the USPTO filing of Micro-Track Device (M-TD^{nm}) assigned the U.S. Provisional No. of 62/995,614, filed on Feb. 5, 2020.

### BACKGROUND OF THE INVENTION

### (1) Field of the Invention

Considering the grounded literature in RFiD technology, the limitations of physics and extant patents, while it's possible to produce a miniature (micro- to nano-scale) RFiD tag with a greater amount of memory (up to 2 kilobytes), such a tag would have a very truncated read-range. This is due to the fact that while a miniature (micro- to nano-scale) antenna can capture sufficient energy from a reader, its inherent limitations of scale are such that it cannot reliably reflect a strong enough signal to a reader/receiver upon interrogation. Hence, to accomplish alternate methods of RFiD-like sensor functionality for the purposes of reduced size we propose OFiD (i.e., Optical Frequency Identification), which likewise requires alternate methods of interrogation, thereby making the Micro-Track Device (M-TD^{nm}) technology distinct from RFiD. This invention relates to a method and system for the asset identification and location.

### (2) Description of Related Art Including Information Disclosed Under 37 CFR 1.97 and 1.98

Not Applicable.

### BRIEF SUMMARY OF THE INVENTION

Micro-Tracking Device (M-TD^{nm}) is a micro-scale technology employing OFiD and Raman scattering (a cumulative process having net effects of scattering photons and changing their frequency). This manipulation of frequency provides a ‘carrier wave’ for M-TD^{nm} interrogation via Raman spectroscopy. The spectrographic interrogation system that overcomes the optical diffraction limit in Tip-Enhanced Raman Scattering (TERS) is an optical interrogation method (OFiD). Said method can be enhanced for tracking & spatial location precision of the M-TD^{nm} device via photonic microscopy (i.e., light scattering) such as interferometric scattering microscopy (iSCAT). This refers to a class of methods that detect and image a subwavelength object by interfering the light scattered by it with a reference light field, thus serving as another mechanism to produce an optical signal in nano-to-micro-scale particle tracking.

### BRIEF DESCRIPTION OF THE SEVERAL VIEWS OF THE DRAWINGS

The following figure descriptions relate to the drawings found in the ‘Drawings’ section:

FIG. 1 shows the M-TD^{nm} aerial perspective, with an outer 6 nm×6 nm substrate, and an internal scale of 2 nm×0.67 nm composed of 2 μm I/O (input/output of Raman spectroscopy & OFiD), 1 μm conduction, and a membrane.

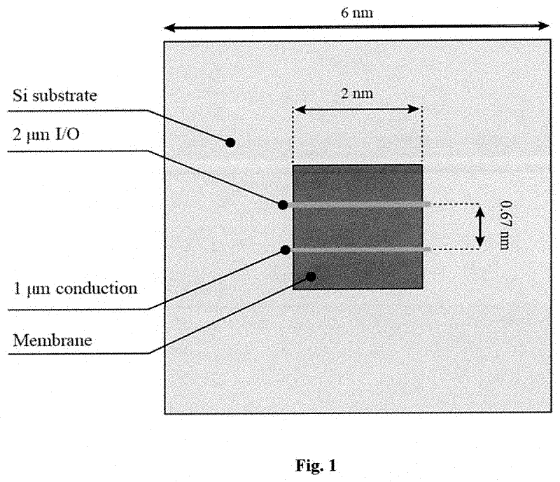

FIG. 2 shows the M-TD^{nm} in lateral perspective: E-beam resist, adhesion layer, membrane layer, and Si frame.

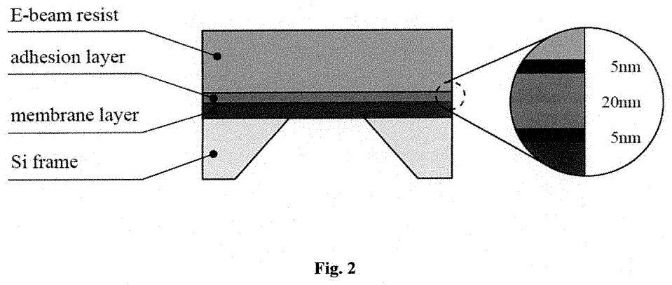

FIG. 3 shows the M-TD^{nm} isometric view perspective, composed of E-beam resist, with an outer 6 nm×6 nm substrate, and an internal scale of 2 nm×0.67 nm composed of 2 μm I/O (input/output of Raman spectroscopy & OFiD), 1 μm conduction, and an adhesion layer, membrane layer, and Si frame.

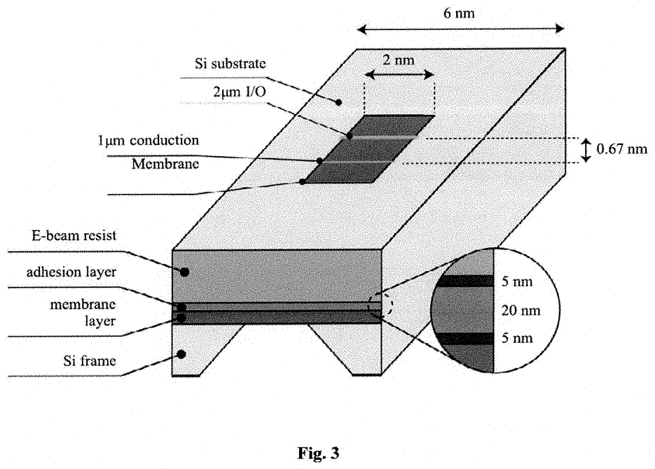

### DETAILED DESCRIPTION OF THE INVENTION

RFiD tags, as a rule, contain an integrated circuit and an antenna, which are used to transmit data to the RFiD reader (or interrogator). Passive tags do not have an active transmitter that communicates with the interrogator, but rather typically couple the transmitter to the receiver with either load-modulation or backscatter (this is near-field/far-field dependent, meaning the proximity of the tag to the of the interrogator). Coupling is the process of transference of energy from one medium to another, passive tags use coupling to obtain power and transfer data. The type of coupling used, inductive or backscatter (also known as radiative), depends on the frequency and the distance between the tag and the interrogator. The boundary between the near-field and far-field is λ/2π (where λ=wavelength). Within the near-field, the magnetic field intensity decays rapidly as 1/d³ (d=distance between the interrogator antenna and the tag). When the magnetic field strength is ultimately translated into power available to the tag, the power attenuates according to 1/d⁶. The magnetic field strength is thus high in the immediate vicinity of the transmitting antenna, but its level is reduced to being negligible in the far-field. In the far-field the power at the tag is attenuated to 1/d². RFiD systems operating at 125-135 kHz and 13.56 MHz operate in the near-field and use inductive coupling, while those operating beyond 100 MHz (e.g., 860-960 MHz and 2400 and 5800 MHz) operate in the far-field and use backscatter (radiative) coupling. The wavelength of the frequency ranges used in inductively coupled RFID system (135 kHz: 2400 m; 13.56 MHz: 22.1 m) is much more than the conductor length in any standard interrogator antenna. It is also many times greater than the distance between the interrogator antenna and the tag antenna. Therefore, the electromagnetic field may be considered as conceptually equivalent to a simple magnetic alternating field with regard to the distance between tag and antenna. The interrogator communicates with the tag by modulating a carrier wave by varying the amplitude (i.e., the phase, or frequency) of the carrier. This modulation can be directly detected as current changes in the coil of the tag. The tag communicates with the interrogator by varying the degree to which the interrogator mechanism loads its antenna. This, in turn, affects the voltage across the interrogator's antenna, which can create sideband frequencies via load-switching on/off in a pattern when coupled into the interrogator antenna. Tags operating at UHF and microwave frequencies use far-field and couple with the interrogator using backscatter. The amount of energy received at the receiver decreases as an inverse of the square of the distance (d) between the interrogator antenna and tag (1/d²).

As a matter of physics, an electromagnetic field propagates outward from the interrogator-antenna, and a proportion of that field (reduced by attenuation) reaches the tag's antenna. The power is supplied to the antenna as high-frequency voltage, and after rectification it can be used to power the tag (or activate/deactivate the tag). Some proportion of the incoming RF energy is reflected by the antenna and reradiated outward into free-space. The amount of energy reflected depends on how well the antenna couples to the electromagnetic wave. RFiD tags that use backscatter to interact with their interrogators have antennas that are designed to resonate well with the carrier signal emitted by the interrogator. The reflection characteristics of the antenna (i.e., the cross-section efficacy), can be mitigated by altering the load connected to the antenna. To transmit data from the tag to the interrogator, a load resistor connected in parallel with the antenna is switched on/off in synchronization with the data stream to be transmitted. The resonant properties of the antenna determine if the tag is an efficient or inefficient reflector. This varies with the strength of the signal reflected from the tag, creating a pattern that is detected at the interrogator as data. This technique is referred to as modulated backscatter. Before the backscattered signal arrives at the interrogator antenna, it experiences forward and backward path loss, interferences in both directions, and absorption by the tag. The reflected signal also travels into the antenna connection of the interrogator in the reverse direction from the original signal. It is decoupled using a directional coupler and is transferred to the receiver input of the interrogator. The forward signal of the transmitter is, likewise, suppressed by the directional coupler.

Further addressing limitations of RFiD, for an RFiD system operating at 13.56 MHz, the approximate distance at which the near-field zone ends is λ/2π, or 3.5 meters. Beyond this distance, the magnetic field is reduced so low that tags cannot be powered. Due to this, the typical read range for 13.56 MHz tags is less than 1 meter. The read distance depends on the size of the interrogator antenna. Typical handheld interrogators can read an electronic identity from ˜2 inches. An interrogator with a large antenna can read a tag up to 2 feet away; where inductive RFiD systems are operated in the near-field, interference from adjacent systems is lower compared to radiatively coupled systems.

While inductive coupling uses near-field effects, backscatter coupling uses far-field effects. Near- and far-field effects are different mechanisms for the transfer of energy through (free) space. In the quantum view of electromagnetic interactions (i.e., interactions at the nano-scale), far-field effects are manifestations of real photons, whereas near-field effects are due to a mixture of real and virtual photons. Virtual photons composing near-field fluctuations and signals have effects that are of shorter range than those of real photons. The reliable nature of quantum-field effects will be capitalized upon as a mechanism for OFiD (i.e., Optical Frequency Identification) which requires alternate methods of interrogation, such as those found in ‘chipless’ RFiD sensor-interrogation (i.e., interrogation executed via Raman Scattering/Raman spectroscopy). Raman spectroscopy is commonly employed to provide a structural fingerprint by which particulate can be identified. Raman spectroscopy is a type of vibrational spectroscopy technique that can be varied. Advantages of Raman scanning include: non-destructive analysis/interrogation; high spatial resolution (even at sub-micron scale); measurement through a barrier; and rapid scanning interrogation (˜10 m/sec to 1 sec exposure to obtain a Raman spectrum reading). The magnitude of the Raman effect correlates with polarizability of the electrons in the M-TD^{nm}.

The component parts of the M-TD^{nm} including Si (silicone molecule) substrate, conduction band, and membrane, provides for an ‘E-beam resist’ function. E-beam resists (electron beam resists) are designed for electron beam applications, are used in electron beam direct writing and multilayer processes, and have effective adhesion with silicon. E-beam resists can be coded in such a way as to provide a unique identifier. Electron spectroscopy refers to a group of analytical techniques of emitted electron energies. Raman spectroscopy is a spectroscopic technique based on Raman scattering. When a substance interacts with the laser beam, the photons from the laser beam interact with molecules, exciting the electrons. The Raman spectrum reading will be interpreted via an optical frequency identification (OFiD). The OFiD employs a laser beam to interact with the molecules of the M-TD's E-beam resist layer, exciting the electrons in order to ‘read’ the output of the interrogation event. The interrogation output is the unique identifier associated with the coded E-beam resist layer.

M-TD^{nm} Power-Scheme

While energy harvesting profiles of the M-TD^{nm} will include kinetic, thermal, vibration and electromagnetic radiation energy harvesting, the following update will focus entirely on electromagnetic energy harvesting, as this is the most ubiquitous, consistent, proliferating and persistent source of energy for passive harvesting.

Electromagnetic energy can be captured from a variety of ambient RF sources which generate high electromagnetic fields. Radio signals have a wide frequency range from 300 GHz to as low as 3 kHz, which are used as a medium to carry energy in the form of electromagnetic radiation. This form of energy harvesting is suitable for powering a larger number of devices distributed in a wide area. The harvested power from various RF sources is between 1 μW to-189 μW at a frequency of around 900 MHz, and a distance of 5 m to 4.1 km. The energy harvesting rate varies significantly depending on the source power and distances involved, however the M-TD^{nm} will operate beyond said tolerances when integrated with IOT.

The M-TD^{nm} wireless energy harvesting power scheme proposes the following energy profiles and approaches to micro- and nano-scale devices.

| Frequency | Internal Resistance | Power Density | Device Volume | |
|---|---|---|---|---|
| (Hz) | (Ω) | (μW/nm³) | (nm³) | Functions |
| 840/1070/1490 | 626 | 0.157/0.014/0.117 | 0.035 | 3 modes & multiple frequencies. |
| | | | | Integrates well with MEMS* |
| | | | | Scalable to nano-. |
| 10 | 1.19 | 2187.5 max. | 160 | Works at low frequencies |

*MEMS (micro-electromechanical system) - a miniature machine that has both mechanical and electronic components. The physical dimension of MEMS can range from several millimeters (mm) to <1 μm (1 micrometer), a dimension many times smaller than the width of a human hair.

Semiconducting nanostructures such as nanowires have been used as building blocks for various types of sensors, energy storage and generation devices, electronic devices and for new manufacturing methods involving low-cost ‘printed’ nanowires. Complimentary to semiconducting nanostructures are the slightly larger optical fibers. In a single-mode optical fiber, and in fact in all silica-based optical fibers, minimal material dispersion occurs naturally at a wavelength of approximately 1.3 μm. The minimum-loss window of single-mode fibers is ˜1.55 μm. When using silica-based optical fibers as component parts of the M-TD^{nm} over semiconducting nanostructures such as nanowires there is a slight increase in the attenuation coefficient, though in power usage difference is negligible. The rate of diminution of average power with respect to distance along a transmission path (i.e., the attenuation coefficient) is negligible precisely because of the small scale.

Light scattering is the key mechanism to produce the optical signal in M-TD^{nm} tracking. M-TD^{nm} size determines scattering regime, from Rayleigh scattering for particles with sizes much smaller than the wavelength of light, to Mie scattering for larger particles with sizes comparable to the wavelength of light (in the event of upscaled variations of the M-TD^{nm} from nano- to micro-scale. In Rayleigh scattering, scattering intensity varies commensurate with the square of the volume of the particle (in this case the M-TD^{nm} device).

The best mode of M-TD^{nm} is asset automated supply chain tool & logistics asset management.

1. The micro- to nano-meter scale component parts of the M-TD^{nm} including Si (silicone molecule) substrate, conduction band, and membrane, provide for an ‘E-beam resist’ function.

2. The E-beam resist layer is coded with an arrangement of electrons, serving as a unique identifier.

3. The M-TD^{nm} will be interrogated via Raman spectroscopy (Raman spectrum reading) will be interpreted via an optical frequency identification (OFiD) method.
